(19) United States
(12) Patent Application Publication
(10) Pub. No.: US 2025/0344191 A1
(43) Pub. Date: Nov. 6, 2025

(54) MULTI-CELL PUCCH CONFIGURATION, APPARATUS, COMPUTER-READABLE STORAGE MEDIUM, AND SOFTWARE PRODUCT

(71) Applicant: ZTE Corporation, Shenzhen (CN)

(72) Inventors: Wei GOU, Shenzhen (CN); Xianghui HAN, Shenzhen (CN); Junfeng ZHANG, Shenzhen (CN); Jing SHI, Shenzhen (CN)

(73) Assignee: ZTE Corporation, Shenzhen (CN)

(21) Appl. No.: 19/265,605

(22) Filed: Jul. 10, 2025

Related U.S. Application Data
(63) Continuation of application No. PCT/CN2023/071963, filed on Jan. 12, 2023.

(51) Int. Cl. H04W 72/044; H04W 72/02; H04W 72/21; H04W 72/232; H04W 76/20

(52) U.S. Cl. CPC H04W 72/044; H04W 72/02; H04W 72/21; H04W 72/232; H04W 76/20

(57) ABSTRACT

A wireless communication method, including obtaining configuration information; and determining one or more PUCCH resources from at least two cells for a PUCCH transmission according to the configuration information, wherein the configuration information includes a PUCCH cell switching pattern configured for the at least two cells. A wireless communication method, including providing configuration information; and receiving, from user equipment, a PUCCH transmission transmitted on one or more PUCCH resources selected from at least two cells according to the configuration information, wherein the configuration information including a PUCCH cell switching pattern configured for the at least two cells.

### TECHNICAL FIELD

This disclosure is generally related to PUCCH transmission, and more particularly to PUCCH transmission on multiple cells.

### BACKGROUND

Wireless communication technologies are pivotal components of the increasingly interconnecting global communication networks. Wireless communications rely on accurately allocated time and frequency resources for transmitting and receiving wireless signals. PUCCH (Physical Uplink Control Channel) carries uplink control information from a user equipment (UE) to a base station (BS). The PUCCH repetition technique provides a better uplink coverage performance for UEs at the cell edge. However, allocation the resources for the PUCCH repetition scheme may have influence to the overall performance of uplink (UL) and downlink (DL) transmission.

### SUMMARY

This summary is a brief description of certain aspects of this disclosure. It is not intended to limit the scope of this disclosure.

According to one embodiment, a wireless communication method is provided. The method includes obtaining configuration information; and determining one or more PUCCH resources from at least two cells for a PUCCH transmission according to the configuration information, wherein the configuration information includes a PUCCH cell switching pattern configured for the at least two cells.

According to one embodiments of this disclosure, a wireless communication method is provided. The method includes providing configuration information; and receiving, from user equipment, a PUCCH transmission transmitted on one or more PUCCH resources selected from at least two cells according to the configuration information, wherein the configuration information including a PUCCH cell switching pattern configured for the at least two cells.

Still another embodiment of this disclosure provides a wireless communication apparatus, including a memory storing one or more programs and a processor electrically coupled to the memory and configured to execute the one or more programs to perform any method or step or their combination in this disclosure.

Still another embodiment of this disclosure provides non-transitory computer-readable storage medium, storing one or more programs, the one or more program being configured to, when performed by a processor, cause to perform any method or step or their combination in this disclosure.

The above and other aspects and their implementations are described in greater detail in the drawings, the descriptions, and the claims.

### BRIEF DESCRIPTION OF THE DRAWINGS

Various exemplary embodiments of the present disclosure are described in detail below with reference to the following drawings. The drawings are provided for purposes of illustration only and merely depict exemplary embodiments of the present disclosure to facilitate the understanding of the present disclosure. Therefore, the drawings should not be considered as limiting of the breadth, scope, or applicability of the present disclosure. It should be noted that for clarity and ease of illustration these drawings are not necessarily drawn to scale.

FIG. 1 shows an exemplary wireless communication system, which can implement the methods and/or steps in this disclosure;

FIG. 2 shows wireless communication between UE and BS via PCell and SCell; and

FIG. 3 shows a cell switching pattern for PUCCH repetitions.

### DETAILED DESCRIPTION

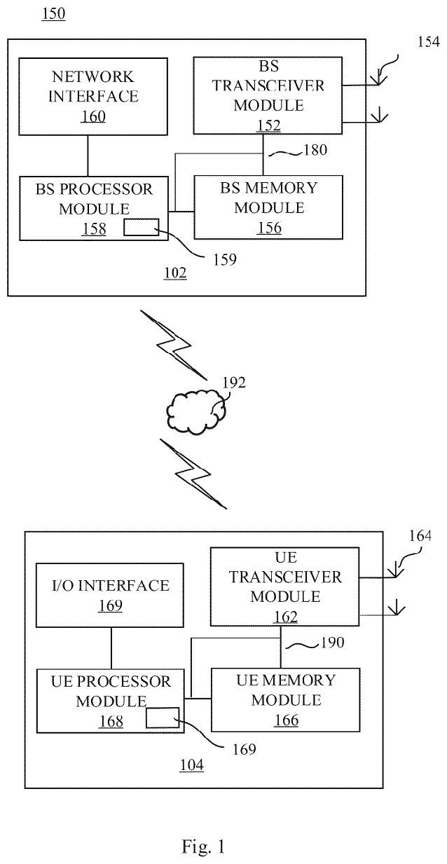

FIG. 1 illustrates a block diagram of an exemplary wireless communication system 150, in accordance with some embodiments of this disclosure. The system 150 may perform the various methods/steps disclosed in this disclosure. The system 150 may include components and elements configured to support operating features that need not be described in detail herein.

The system 150 may include a base station (BS) 102 and a user equipment (UE) 104. The BS 102 includes a BS transceiver or transceiver module 152, a BS antenna system 154, a BS memory or memory module 156, a BS processor or processor module 158, and a network interface 160. The components of BS 102 may be electrically coupled and in communication with one another as necessary via a data communication bus 180. Likewise, the UE 104 includes a UE transceiver or transceiver module 162, a UE antenna system 164, a UE memory or memory module 166, a UE processor or processor module 168, and an I/O interface 169. The components of the UE 104 may be electrically coupled and in communication with one another as necessary via a date communication bus 190. The BS 102 communicates with the UE 104 via a communication channel 192, which can be any wireless channel or other medium known in the art suitable for transmission of data as described herein.

As would be understood by persons of ordinary skill in the art, the system 150 may further include any number of modules other than the modules shown in FIG. 1. Those having ordinary skill in the art will understand that the various illustrative blocks, modules, circuits, and processing logic described in connection with the embodiments disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software depends upon the particular application and design constraints imposed on the overall system. Those familiar with the concepts described herein may implement such functionality in a suitable manner for each particular application, but such implementation decisions should not be interpreted as limiting the scope of the present disclosure.

A wireless transmission from a transmitting antenna of the UE 104 (referred to singular form for convenience, but can include multiple antennae) to a receiving antenna of the BS 102 (referred to singular form for convenience, but can include multiple antennae) is known as an uplink (UL) transmission, and a wireless transmission from a transmitting antenna of the BS 102 to a receiving antenna of the UE 104 is known as a downlink (DL) transmission. In accordance with some embodiments, the UE transceiver 162 may be referred to herein as an “uplink” transceiver 162 that includes a RF transmitter and receiver circuitry that are each coupled to the UE antenna 164. A duplex switch (not shown) may alternatively couple the uplink transmitter or receiver to the uplink antenna in time duplex fashion. Similarly, in accordance with some embodiments, the BS transceiver 152 may be referred to herein as a “downlink” transceiver 152 that includes RF transmitter and receiver circuitry that are each coupled to the antenna array 154. A downlink duplex switch may alternatively couple the downlink transmitter or receiver to the downlink antenna array 154 in time duplex fashion. The operations of the two transceivers 152 and 162 are coordinated in time such that the uplink receiver is coupled to the uplink UE antenna 164 for reception of transmissions over the wireless communication channel 192 at the same time that the downlink transmitter is coupled to the downlink antenna array 154. There may be close synchronization timing with only a minimal guard time between changes in duplex direction. The UE transceiver 162 communicates through the UE antenna 164 with the BS 102 via the wireless communication channel 192. The BS transceiver 152 communicates through the BS antenna 154 of a BS (e.g., the first BS 102) with the other BS (e.g., the second BS 102-2) via a wireless communication channel 192. The wireless communication channel 196 can be any wireless channel or other medium known in the art suitable for direct communication between BSs.

The UE transceiver 162 and the BS transceiver 152 are configured to communicate via the wireless data communication channel 192, and cooperate with a suitably configured RF antenna arrangement 154/164 that can support a particular wireless communication protocol and modulation scheme. In some exemplary embodiments, the UE transceiver 162 and the BS transceiver 152 are configured to support industry standards such as the Long-Term Evolution (LTE) and 5G standards (e.g., NR), and the like. It is understood, however, that the invention is not necessarily limited in application to a particular standard and associated protocols. Rather, the UE transceiver 162 and the BS transceiver 152 may be configured to support alternative, or additional, wireless data communication protocols, including future standards or variations thereof.

The processor modules 158 and 168 may be implemented, or realized, with a general-purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor module may be realized as a microprocessor, a controller, a microcontroller, a state machine, or the like. A processor module may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the embodiments disclosed herein may be embodied directly in hardware, in firmware, in a software module performed by processor modules 158 and 168, respectively, or in any practical combination thereof. The memory modules 156 and 166 may be realized as RAM memory, flash memory, EEPROM memory, registers, ROM memory, EPROM memory, a hard disk, a removable disk, a CD-ROM, or any other form of storage medium known in the art. In this regard, the memory modules 156 and 166 may be coupled to the processor modules 158 and 168, respectively, such that the processors modules 158 and 168 can read information from, and write information to, memory modules 156 and 166, respectively. The memory modules 156 and 166 may also be integrated into their respective processor modules 158 and 168. In some embodiments, the memory modules 156 and 166 may each include a cache memory for storing temporary variables or other intermediate information during execution of instructions to be performed by processor modules 158 and 168, respectively. The memory modules 156 and 166 may also each include non-volatile memory for storing instructions to be performed by the processor modules 158 and 168, respectively.

The network interface 160 generally represents the hardware, software, firmware, processing logic, and/or other components of the base station 102 that enable bi-directional communication between BS transceiver 152 and other network components and communication nodes configured to communication with the BS 102. For example, network interface 160 may be configured to support internet or WiMAX traffic. In a typical deployment, without limitation, network interface 160 provides an 802.3 Ethernet interface such that BS transceiver 152 can communicate with a conventional Ethernet based computer network. In this manner, the network interface 160 may include a physical interface for connection to the computer network (e.g., Mobile Switching Center (MSC)) or one or more core network for mobile communications. The terms “configured for” or “configured to” as used herein with respect to a specified operation or function refers to a device, component, circuit, structure, machine, signal, etc. that is physically constructed, programmed, formatted and/or arranged to perform the specified operation or function. The network interface 160 could allow the BS 102 to communicate with other BSs or a CN over a wired or wireless connection.

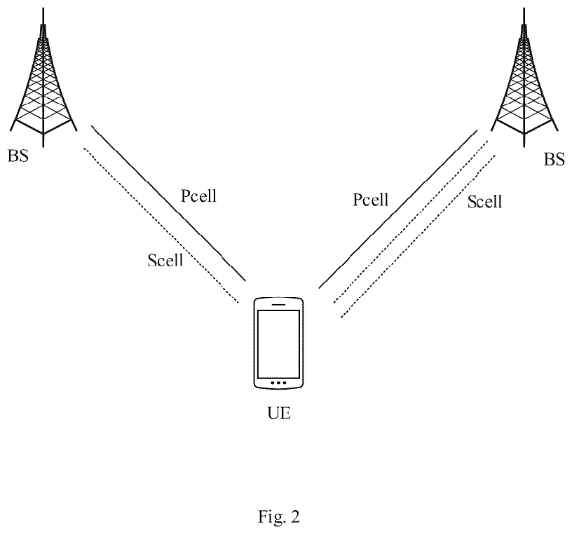

FIG. 2 shows exemplary wireless communication between UE and one or more BSs. According to FIG. 2, UE can establish wireless communication with one or more BSs. The wireless communication can be carried by one PCell (Primary Cell) and one or more SCells (Secondary Cell).

PUCCH (Physical Uplink Control Channel) carries a set of information “UCI (Uplink Control Information).” Depending on what kind of information the UCI in PUCCH carries, PUCCH is classified into various formats. The content of the UCI may include, for example, channel quality information (CSI), acknowledgements (ACK/NACK), and scheduling requests (SR). PUCCH repetitions transmission may improve PUCCH reliability and coverage. The repetition technique allows UE to transmit the same or similar PUCCH repetitively to ensure a BS receives accurate information to management the signal transmission between the BS and the UE. PUCCH repetition factors may control the times a PUCCH transmitted repetitively for a cycle. A PUCCH repetition factor N can be generally configured or indicated as 2, 4 or 8. The repetitions can be a pre-determined factor between the BS or UE, and it can also be a factor indicated by an RRC (Radio Resource Control) signaling. Therefore, after a PUCCH with repetitions is triggered, the PUCCH is repeatedly transmitted 2 (N=2), 4 (N=4) or 8 (N=8) times according to the configured or indicated repetition factor.

Traditionally, a PUCCH with repetitions is only transmitted in a PCell, and the corresponding PUCCH resources are only assigned from the resources of the PCell for the transmission of the PUCCH repetition.

For a PUCCH with repetition factor N (N>1), the time slot or subslot where the first PUCCH repetition is transmitted may be configured or indicated by UE who transmits the PUCCH. In a Time Division Duplex (TDD) cell, the slots of the remaining PUCCH repetitions can be determined based on at least one or more of the following rules: If a UL symbol or flexible symbol can be provided in a slot; the UL symbol or flexible symbol is of the same symbol (for example, with the same symbol index in the slot) with the starting symbol configured for the PUCCH; and/or in the slot, starting from the UL symbol or flexible symbol, consecutive following UL symbols or flexible symbols can be provided, and the total number of consecutive UL symbols or flexible symbols is greater than or equal to the number of symbols configured for the PUCCH (such that there is a sufficient space/symbols to fit the PUCCH). Then, a slot meeting the requirements can be determined for the remaining PUCCH repetitions.

According to one example, the first PUCCH and the remaining PUCCH(s) can use the same PUCCH resource. Traditionally, all repetitions of a PUCCH with repetitions is only transmitted in the PCell. In addition, the same PUCCH resource is used for all repetitions. The same configured PUCCH resource for the PUCCH repetition is selected from a PUCCH resource set configured for the PCell.

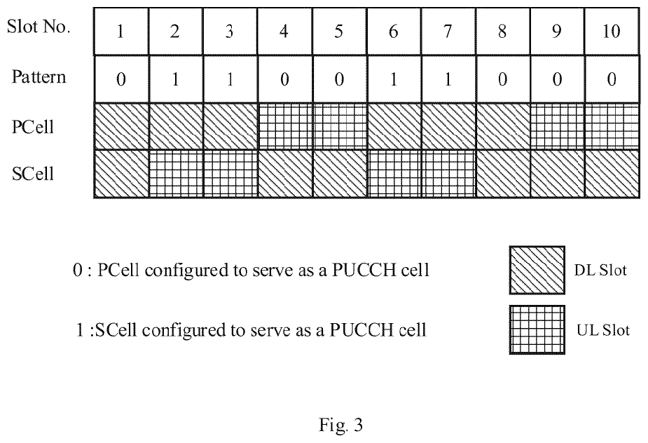

According to one example, PUCCH cell switching can be supported and configured between two TDD (Time Division Duplex) cells. This set up may reduce latency of PUCCH transmission. But this set up is currently available only for PUCCH transmission without repetitions. Exemplarily, the PUCCH cell (a cell used to transmit a PUCCH) may be determined on a slot by slot basis between a PCell and one or more SCells according to a configured PUCCH cell switching pattern. The PUCCH cell switching pattern can be configured by a BS via RRC (Radio Resource Control) signaling. Referring to FIG. 3 as an example, an example PUCCH cell switching pattern is displayed. A pattern can be configured on a slot by slot basis in the time domain between the PCell and the SCell. The “0” indicates that the PUCCH cell is the PCell (meaning that the PUCCH is transmitted on the PCell), and the “1” indicates that the PUCCH cell is the SCell (meaning that the PUCCH is transmitted on the SCell). It should be noted that, in some example set up, if a slot corresponding to the PUCCH cell during a PCell slot is a slot of a downlink (DL) slot, then the PUCCH cannot be transferred in the slot.

This disclosure provides various embodiments regarding PUCCH transmission using PCell, SCell, or both.

### Embodiment 1

According to one embodiment, UE can be configured with PUCCH cell switching function between N TDD cells, N being an integer greater than 1. The PUCCH cell switching function can be configured according to, for example, the configured PUCCH cell switching pattern as shown in FIG. 3. If the UE is scheduled or configured to transfer a PUCCH with repetitions from slot n, the UE may expect to obtain N PUCCH resources from the N cells respectively. According to the pattern of PUCCH cell switching, if a cell corresponding to a PUCCH resource in the N PUCCH resources is determined to be a PUCCH cell from N cells, then the PUCCH resource can be used to transmit the PUCCH repetitions. The following implementation use two cells, one PCell and one SCell, as an example. The same method should be able to readily expand to operations on more than two cells.

### PUCCH Resource Assignment

According to one implementation, the UE can obtain two PUCCH resources according to the instructions in DCI (downlink Control Information) in PDCCH (Physical Downlink Control Channel). In the DCI, two PUCCH resource indication fields (e.g., PRI fields) are introduced. The PRI fields may be respectively associated with two cells configured with PUCCH cell switching. For example, one PRI field is associated with the PCell, and the other one PRI field is associated with the SCell.

In other words, if PUCCH cell switching is configured between N cells, M PRI fields will be introduced. In one example, M may be equal to N (where M and N are positive integers). Each PRI field may be associated with one of the N cells. A PUCCH transmission with repetitions can be transmitted in one or more slots of the PUCCH cell determined or selected from the N cells according to a pattern of PUCCH cell switching. Alternatively or additionally, M may be less than N. In this case, each of more than one cells (e.g., L cells) may be associated with a PRI field. A PUCCH transmission with repetitions can be transmitted in the slot of the PUCCH cell determined or selected from the L cells according to the pattern of PUCCH cell switching.

In an example, a PUCCH resource (recorded as PUCCH1) is configured in the PUCCH resource set of a PCell (where the configured repetition factor is 2, that is, the PUCCH is transmitted twice repeatedly). A PUCCH resource (recorded as PUCCH-1) is configured in the PUCCH resource set of a SCell (where the configured repetition factor is 2). The two PRI domains are configured in DCI and are recorded as PRI1 and PRI2 respectively. PRI1 is associated with the PCell, and PRI2 is associated with the SCell. In FIG. 3, the UE can be instructed to transmit a PUCCH with a repetition factor of 2 starting from the PCell slot n.

Referring to Table 1 as an example PUCCH cell switching pattern, the PUCCH cell can be determined for each PCell slot according to the configured PUCCH cell switching pattern. PUCCH cell may configured on a slot by slot basis from Slot n−1 to Slot n+4. The designation of the PUCCH cell slot may also follow the pattern and switch between PCell and SCell.

TABLE 1

| | Slot | | Slot | Slot | Slot | Slot |
|---|---|---|---|---|---|---|
| | n − 1 | Slot n | n + 1 | n + 2 | n + 3 | n + 4 |
| Pattern | 1 | 0 | 1 | 1 | 1 | 0 |
| PCell | DL | UL | DL | DL | DL | UL |
| SCell | DL | DL | UL | UL | UL | DL |

0 indicates PCell is a PUCCH Cell
1 indicates SCell is a PUCCH Cell

In an example, a BS may indicate the PUCCH resource, PUCCH1, of the PCell and the PUCCH resource, PUCCH-1, of the SCell for UE through the two PRI fields, PRI1 and PRI2, in one or more DCI pieces, respectively. After the UE receives the one or more DCI, the resource PUCCH1 and PUCCH-1 can be indicated by the fields PRI1 and PRI2, respectively. In this way, the two PUCCH resources, PUCCH1 and PUCCH-1, in different cells can be associated for a PUCCH transmission with repetitions. Then, the two resources PUCCH1 and PUCCH-1 of the respective cells can be used to perform PUCCH transmission with repetitions between the PCell and the SCell according to the PUCCH cell switching pattern.

When the slot determined for the PUCCH transmission is a PCell slot, the UE may transmit the PUCCH1 resource and accumulate the number of the repetitions at the PCell slot; when the slot determined for the PUCCH transmission is SCell slot, the UE may transmit the PUCCH-1 resource and accumulate the number of repetitions at the SCell slot. In this example, the transmission of the PUCCH either in the PCell or the SCell would increase the number of the PUCCH repetitions toward the target number set up by a repetition factor. That is, the number of the PUCCH repetitions is accumulated across the PCell and the SCell.

In FIG. 3, the UE may transmit the PUCCH1 in PCell slot n for the first PUCCH repetition as the pattern indicates that the PCell is the PUCCH cell. The UE can also be scheduled or configured to start a PUCCH transmission with repetitions from the SCell slot, alternatively. Then, according to the pattern of PUCCH cell switching, the UE may determine a cell for transmitting the subsequent repetitions in the following slot n+1 to slot n+4. Since the subsequent PUCCH cell is SCell in slot n+1 as indicated by the pattern (assuming that SCell's slot n+1 is determined to meet the requirements of the remaining PUCCH repetitions), the UE transmits PUCCH-1 in SCell slot n+1 for the second PUCCH repetition. In a case where the repetition factor of the PUCCH is 2, a PUCCH transmission with two repetitions is completed across the PCell and SCell.

For UE in an example, if the pattern of the PUCCH cell switching is configured between the PCell and the SCell, a PUCCH transmission with repetitions is scheduled or triggered, and the PUCCH resources are indicated respectively for the PCell and the SCell configured with the pattern of the PUCCH cell switching, the repetitions of the PUCCH transmission are transmitted in the slot of the PUCCH cell determined from the PCell and SCell according to the pattern, using the PUCCH resource corresponding to the PUCCH cell determined to transmit the PUCCH resource.

It should be noted that a PUCCH cell switching pattern may be used even when the PUCCH transmission is without the transmission. According to one embodiment of this disclosure, the PUCCH cell switching pattern can be used to identify a PUCCH cell (the cell that is selected for transmitting a PUCCH) among at least two candidate cells. The PUCCH cell switching pattern as shown in FIG. 3 is just an example, the pattern can be modify according to different applications and settings.

According to one embodiment, the slot of PUCCH cell of the first PUCCH repetition is indicated or determined according to the configured PUCCH period; the slots of PUCCH cell corresponding to the remaining PUCCH repetitions can be determined according to the exemplary following rules: If a slot of PUCCH cell satisfies the following conditions 1 and 2, the slot of PUCCH cell can be determined for the remaining PUCCH repetitions.

Condition 1: A slot of a PUCCH cell can provide a UL symbol or flexible symbol, and the UL symbol or flexible symbol is the same as the starting symbol of the PUCCH resource indicated or configured for the PUCCH cell for the transmission.

In this above example, if a PCell is determined to be the PUCCH cell according to the pattern, the indicated PUCCH1 can be used as the resource of the PUCCH transmission with repetitions in the PCell. If the slot of the PUCCH cell is a PCell slot according to the pattern of PUCCH cell switching, the UL symbol or flexible symbol of the subsequent slot may be the same as the starting symbol of the indicated PUCCH1 for the PCell. Likewise, in this example, if a SCell is determined to be the PUCCH cell according to the pattern, the indicated PUCCH-1 can be used as the resource of the PUCCH transmission with repetitions in the SCell. If the slot of the PUCCH cell is a SCell slot, the UL symbol or flexible symbol of the subsequent time slot is required to be the same as the starting symbol of the indicated the PUCCH-1 for the SCell.

Condition 2: The slot of a PUCCH cell can provide continuous UL symbols or flexible symbols starting from the UL symbol or flexible symbol in Condition 1, and the number of the continuous symbols is greater than or equal to the number of symbols of the PUCCH resource indicated for the PUCCH cell.

In this example, if a PCell is determined to be the PUCCH cell according to the pattern, the indicated PUCCH1 can be used as the resource of the PUCCH transmission with repetitions in the PCell. If the slot of the PUCCH cell is a PCell slot according to the pattern of PUCCH cell switching, the number of the consecutive symbols starting from the UL symbol or flexible symbol may need to be greater than or equal to the number of symbols of PUCCH1 for the PCell. Likewise if a SCell is determined to be the PUCCH cell according to the pattern, the indicated PUCCH-1 can be used as the resource of the PUCCH transmission with repetitions in the SCell. If the PUCCH cell slot is a SCell slot according to the pattern of PUCCH cell switching, the number of the consecutive symbols starting from the UL symbol or flexible symbol may be required to be greater than or equal to the number of symbols of PUCCH-1 for the SCell.

It should be noted that the PUCCH cell may be switched from a PCell to a SCell or from a SCell to a PCell, and the conditions still apply. A new cell may provide a slot that meet the above condition 1 and condition 2 to fit the PUCCH repetition for transmission.

According to one embodiment, the PUCCH1 from PCell and the PUCCH-1 from SCell are associated resources for a PUCCH transmission with repetitions. The association can be configured by an RRC signaling or be predefined. Associated PUCCH resources from different cells may exemplarily have at least one of the following characteristics:
(1) The associated PUCCH(s) resources may have the same number of symbols;
(2) The associated PUCCH(s) resources may have the same PUCCH format;
(3) The associated PUCCH(s) resources may have the same code rate;
(4) The associated PUCCH(s) resources may have the same coding and modulation;
   (5) The associated PUCCH(s) resources may have the same subcarrier spacing (SCS);
(6) The associated PUCCH(s) resources may have the same cyclic prefix (CP); or
(7) The associated PUCCH(s) resources may have the same repetition factor.

### Embodiment 2

According to one example, UE may be configured with a PUCCH cell switching function between N (TDD) cells according to the configured PUCCH cell switching pattern. If the UE is scheduled or configured to transfer a PUCCH with repetitions from slot n, the UE expects to obtain N PUCCH resources from the N cells respectively. Similarly according to the pattern of PUCCH cell switching (exemplarily as shown in FIG. 3), if a cell corresponding to a PUCCH resource in N PUCCH resources is determined to be a PUCCH cell from N cells, the PUCCH resource of the selected cell has the opportunity to be used for the repetition of PUCCH with repetitions in the cell. For ease of illustration, the examples below use two cells as an example, the same method can be readily applied to operation among three or more cells.

### PUCCH Resource Assignment

According to one implementation, a BS and UE may agree that a table (or other format) may be used to associate PUCCH resources from different cells. The table may be used to indicate the association of PUCCH resources in different cells. The PUCCH resources configured with the association relationship in this table can be used for the different repetitions of PUCCH transmission with repetitions in the corresponding cells configured with the pattern of PUCCH cell switching. Through this table (or other types of data structures), an association relationship can be established between PUCCH resources from different cells, which are configured to support PUCCH cell switching.

Thereby, if a PUCCH transmission with repetitions is scheduled or triggered across a PCell and a SCell according to the pattern of the PUCCH cell switching, the UE can determine one PUCCH resource from the PCell and another PUCCH resource from the SCell based on the table and can use the determined PUCCH resources for different repetitions of the PUCCH transmission in the corresponding cell.

In one implementation, up to 256 PUCCH resources can be configured in a cell. These configured PUCCH resources can be given corresponding ID. In addition, the PUCCH resource can be configured with a repetition factor for each PUCCH resource by an RRC signaling. Alternatively or additionally, DCI can indicate a repetition factor for the scheduled PUCCH resource.

Tables 2 to 6 below show several examples of establishing an association relationship for the PUCCH resources of two cells. The association can be established between more cells. In actual implementation, the association need not to be established in a format of a table. The association can be indicated via different data structures.

In Tables 2 to 6, each row shows two association PUCCH resources respective in the two cells, a PCell and a SCell. For example, PUCCH1 of PCell is associated with PUCCH-1 of the SCell, and PUCCH2 of the PCell is associated with PUCCH-2 of the SCell. The table can be expaned to include a third column to include PUCCH resources of a third cell, in order to establish the association between Cell1 to Cell3. The resources PUCCH1, PUCCH2, and PUCCH3 in Tables 2 to 6 come from the PUCCH resources configured for Cell1 (PCell). The resources PUCCH-1, PUCCH-2, and PUCCH-3 in Tables 2 to 6 come from the PUCCH resources configured for cell2 (SCell). The PUCCH resources from different cells in each row in the Tables are associated, and they can be used for different repetitions of the same PUCCH transmission in the corresponding cells.

TABLE 2

| Cell1 (PCell) | Cell2 (SCell) |
|---|---|
| PUCCH1 | PUCCH-1 |
| PUCCH2 | PUCCH-2 |
| PUCCH3 | PUCCH-3 |
| . . . | . . . |

TABLE 3

| Index/PRI value | Cell1 (PCell) | Cell2 (SCell) |
|---|---|---|
| 0 | PUCCH1 | PUCCH-1 |
| 1 | PUCCH2 | PUCCH-2 |
| 2 | PUCCH3 | PUCCH-3 |
| . . . | . . . | . . . |

TABLE 4

| | | Cumulative number |
|---|---|---|
| Cell1 (PCell) | Cell2 (SCell) | of repetitions |
| PUCCH1 | PUCCH-1 | 4 |
| PUCCH2 | PUCCH-2 | 2 |
| PUCCH3 | PUCCH-3 | 8 |
| . . . | | |

TABLE 5

| | | | Cumulative number |
|---|---|---|---|
| Index/PRI value | Cell1 (PCell) | Cell2 (SCell) | of repetitions |
| 0 | PUCCH1 | PUCCH-1 | 4 |
| 1 | PUCCH2 | PUCCH-2 | 2 |
| 2 | PUCCH3 | PUCCH-3 | 8 |
| . . . | . . . | . . . | . . . |

TABLE 6

| Cell1 (PCell) | Cell2 (SCell) |
|---|---|
| PUCCH1 | NULL |
| NULL | PUCCH-2 |
| PUCCH3 | PUCCH-3 |
| . . . | . . . |

Optionally, the PUCCH resources in Table 2 can be PUCCH resources with a repetition factor greater than 1. Alternatively, the PUCCH resources in Table 2 can also be PUCCH resources without repetition factor, meaning that, the repetition factor is 1, and that there is no repeated transmission.

Table 3 adds an extra index/PRI value to index each row as compared to Table 2. For example, in Table 3, the PUCCH1 and PUCCH-1 in the row with index 0 are associated with each other. In this way, they can be used for PUCCH transmission with repetitions across PCell and SCell configured with the PUCCH cell switching pattern, and the number of repetitions of the PUCCH transmission is accumulated based on the number of PUCCH1 and PUCCH-1 transmissions.

Table 4 and 5 add a column of cumulative numbers of repetitions for each row. That is, if the PUCCH resource in a row is determined to be used for a PUCCH transmission with repetitions, then the repetition factor of the PUCCH transmission is set to equal to the value corresponding to the cumulative numbers of repetitions as indicated in the corresponding row in Table 4 or 5. The transmission times of the repetitions would be counted across the Cell1 and Cell2 until it reaches the indicated cumulative number in Table 4 or Table 5.

Table 6 shows that in some row there may be no PUCCH resource assigned correspondingly. Therefore, PUCCH-2 is associated with no corresponding resource in Cell1; that is, if the PUCCH resource in the row is determined for a PUCCH transmission with repetitions, then all repetitions of the PUCCH transmission can only use PUCCH-2 and be transmitted in Cell2.

Optionally or alternatively, the PUCCH resources of different cells associated with each other in the same row have at least one of the following characteristics to possess the same number of symbols, the same PUCCH format, the same code rate, the same coding and modulation, the same subcarrier spacing (SCS), the same cyclic prefix (CP), or the same repetition factor.

### Repetition Factor Configuration

According to one implementation with a reference to the above tables, e.g., Table 2 and Table 3, the number of repetitions (or the repetition factor(s)) of a PUCCH transmission across PCell and SCell (or more cells) can be determined based on a number of repetitions of the PUCCH resources indicated for the first repetition of the PUCCH transmission. For example, the PUCCH resource used to transmitted the PUCCH may be configured with a repetition factor or have a predefined repetition factor. The repetition factor can be configured, for example, via an RRC signaling. The BS and UE may agree that when (1) the UE is configured with PUCCH cell switching between PCell and SCell, (2) a PUCCH transmission across PCell and SCell is scheduled or triggered, and/or (3) a PUCCH resource for the PUCCH transmission is indicated to start from a PCell (or a SCell), the total number of repetitions of the PUCCH transmission between PCell and SCell can be equal to the number of repetitions configured for the indicated PUCCH resource for the first repetition of the PUCCH transmission.

For example, when PUCCH transmission is scheduled and starts from PCell, and the PUCCH1 in PCell is indicated for the first repetition of the PUCCH transmission, UE can determine that PUCCH-1 can also be used for the PUCCH transmission in SCell according to the tables above. If the number of repetitions configured for PUCCH1 is 2 through an RRC signaling, and the number of repetitions configured for PUCCH-1 is 4 through an RRC signaling. The number of repetitions of the PUCCH transmission can be equal to the number of repetitions configured for the indicated PUCCH1 for the first repetition of the PUCCH transmission, that is, equal to 2. Namely in this example, PUCCH1 is the indicated PUCCH resource for the first repetition of the PUCCH transmission, and PUCCH-1 is not the indicated PUCCH resource for the first repetition of the PUCCH transmission; therefore, the PUCCH repetition factor of PUCCH1 would be followed. In this way, the number of the repetitions of the PUCCH transmission can be accumulated twice (as the repetition factor is 2 across PCell using PUCCH1 and SCell using PUCCH-1. Exemplarily, the first repetition of the PUCCH would be transmitted on PUCCH1, and the other one can be transmitted on PUCCH-1 as the second repetition of the PUCCH.

As another example, when a PUCCH transmission is scheduled and starts from the SCell, and PUCCH-1 in the SCell is indicated for the first repetition of the PUCCH transmission, UE can determine that PUCCH1 can also be used for the PUCCH transmission in the PCell according to Table 2. If the number of repetitions configured for PUCCH1 is 2 configured through an RRC signaling, and the number of repetitions configured for PUCCH-1 is 4 configured through an RRC signaling, the number of repetitions of the PUCCH transmission can be equal to the number of repetitions configured for the indicated PUCCH-1, that is, equal to 4. Namely here, PUCCH-1 is the indicated PUCCH resource the first repetition of the PUCCH transmission, and PUCCH1 is not the indicated PUCCH resource the first repetition of the PUCCH transmission; therefore, the number of repetitions of the PUCCH transmission can be accumulated four times across PCell using PUCCH1 and SCell using PUCCH-1. Exemplarily, the first repetition of the PUCCH would be transmitted on PUCCH-1, and the remaining repetitions of the PUCCH can be transmitted on PUCCH1 or PUCCH-1.

According to an implementation, the number of repetitions of a PUCCH transmission can be determined according to a sum of the number of repetitions of the PUCCH resource indicated for the first repetition of the PUCCH transmission and the number of repetitions of the PUCCH resource associated with the indicated PUCCH resource. The number of repetitions of a PUCCH resource can be configured through RRC signaling. In this way, if the pattern of PUCCH cell switching is configured and a PUCCH transmission with repetitions is scheduled or triggered, the number of repetitions of the PUCCH transmission is equal to the sum of the number of repetitions configured for the PUCCH resources determined for the PUCCH transmission.

Accordingly, when the UE is configured with PUCCH cell switching between the PCell and the SCell, the UE may first determine the PUCCH resources of the different cells for the PUCCH transmission based the Tables above. Then the number of repetitions of the PUCCH transmission is equal to the sum of the number of repetitions configured for the determined PUCCH resources among the different cells.

For example, when a PUCCH transmission is scheduled and starts from the PCell and PUCCH1 in the PCell is indicated for the first repetition of the PUCCH transmission, UE can determine that PUCCH-1 can also be used for the PUCCH transmission in the SCell according to Table 2. If the number of repetitions configured for PUCCH1 is 2 through an RRC signaling and the number of repetitions configured for PUCCH-1 is 2 through an RRC signaling, the number of repetitions of the PUCCH transmission is equal to the sum of the number of repetitions configured for PUCCH1 and the number of repetitions configured for PUCCH-1, that is, equal to four (2+2). Therefore, the number of repetitions of the PUCCH transmission can be accumulated four times across the PCell using PUCCH1 and SCell using PUCCH-1.

According to an implementation, the number of repetitions of a PUCCH transmission can be indicated based on a parameter in the DCI. In this way, the PUCCH resource does not need to be configured with the number of repetitions in advance. If a PUCCH transmission is scheduled and a PUCCH resource is indicated for the PUCCH transmission based on the DCI, the number of repetitions of the PUCCH transmission can also be indicated in the DCI.

In this way, if the UE is configured with PUCCH cell switching between the PCell and the SCell, the UE can determine the PUCCH resources of the different cells for the PUCCH transmission based on the tables above.

For example, if a PUCCH transmission is scheduled or triggered and starts from the PCell and the PUCCH1 is indicated for the PUCCH transmission, the UE can determine that the PUCCH-1 is also used for the PUCCH transmission in the SCell based on the PUCCH1 ID and the tables. Assuming the number of repetitions of the PUCCH transmission is indicated as 4 in the DCI, the number of repetitions of the PUCCH transmission can be accumulated four times across PCell (using PUCCH1) and SCell (using PUCCH-1).

As described above with a reference to Table 4 and Table 5, a column can be introduced to indicate the cumulative number of repetitions of a PUCCH transmission across two cells using the associated PUCCH resource. For example, if a PUCCH transmission is scheduled and starts from the PCell and the PUCCH1 in the PCell is indicated for the PUCCH transmission, UE may determine that the PUCCH-1 is also used for the PUCCH transmission according to the PUCCH1 ID and Table 4. UE can determine that the number of repetitions of the PUCCH transmission is 4 according to the “Cumulative number of repetitions” column. Thereby, the number of repetitions of the PUCCH transmission can be accumulated for a total of 4 times across the PCell using PUCCH1 and the SCell using PUCCH-1.

As another example, if a PUCCH transmission is scheduled and starts from the SCell and the PUCCH-1 in the SCell is indicated for the PUCCH transmission, UE can determine that the PUCCH1 is also used for the PUCCH transmission according to the PUCCH-1 ID and Table 5. UE can determine that the number of repetitions of the PUCCH transmission is 4 according to the “Cumulative number of repetitions” column. The number of repetitions of the PUCCH transmission can be accumulated for a total of 4 times across the PCell using PUCCH1 and the SCell using PUCCH-1.

### PUCCH Resources Determination

According to one implementation alternatively or additionally, the BS and the UE may agree that when the UE is configured with a PUCCH cell switching between a PCell and a SCell and a PUCCH transmission is triggered or scheduled, the UE may determine that the PUCCH resource is used for the PUCCH transmission from Table 3 and Table 5 above according to a PRI value in the DCI. For example, if the PRI value in the DCI is 0, it indicates to the UE that PUCCH1 in PCell and PUCCH-1 in SCell are used for the PUCCH transmission.

In the above tables, PUCCH resources in different cells can be configured optionally. For example, it is possible that only one PUCCH resource, either one PUCCH resource of one cell, is configured. For example, a PUCCH resource can be configured for PCell, and at the same time, no PUCCH resource is configured for SCell as its association in the same row of the tables. Likewise, it is possible that a PUCCH resource is configured for SCell, and no PUCCH resource is configured for PCell as its association on the same row. In these examples, if a PUCCH transmission with repetitions is scheduled or triggered, all repetitions of the PUCCH transmission are only transmitted in the cell corresponding to the determined PUCCH resource under the cell with a configured PUCCH resource.

For example, in the first row of Table 6, the PUCCH1 corresponding to the PCell is configured, but the PUCCH resource corresponding to the SCell is not configured. In this way, if the PUCCH resource in the first row of Table 6 is determined for a PUCCH transmission with repetitions, all repetitions of the PUCCH transmission can only be transmitted in the PCell using PUCCH1.

For example, in the second row of Table 6, the PUCCH resource corresponding to the PCell is not configured, but the PUCCH-2 corresponding to the SCell is configured. In this way, if the PUCCH resource in the second row of Table 6 is determined for a PUCCH transmission with repetitions, all repetitions of the PUCCH transmission can only be transmitted in the SCell using PUCCH-2.

Traditionally, a PUCCH resource can be obtained from a set of PUCCH resources based on a PRI value. However, after the introduction of the above table, PUCCH resources can also be obtained from the table according to the PRI value. The disclosure below discuss whether the PUCCH resources can be determined by using the tables or a PRI value.

According to one implementation, a BS and UE may agree that a PUCCH resource is always determined from the set of PUCCH resources according to the PRI value, regardless of whether the PUCCH cell switching is configured between a PCell and a SCell. In this way, the associated PUCCH resource needs to be determined according to the ID of the determined PUCCH resource and the above table.

According to another implementation, if UE is configured with the pattern of PUCCH cell switching between a PCell and a SCell and the above table is configured, the PUCCH resource is always determined from a table like any one above according to the PRI value. In this way, the associated PUCCH resources for PCell and SCell can be directly determined based on the PRI value.

According to another implementation, an RRC signaling or a DCI signaling can be used to indicate that the PUCCH resource is determined from the PUCCH resource set or from a configured table according to the PRI value.

### UE-Triggered PUCCH/Periodic PUCCH

For a PUCCH transmission with repetitions triggered by UE, such as SR PUCCH, or for periodic PUCCH, such as CSI PUCCH, since the PUCCH transmission has no corresponding DCI, the operation to determine the associated PUCCH resource can be implemented according to the following examples.

A BS and UE may agree that if the UE is configured with the pattern of PUCCH cell switching between a PCell and a SCell, the above table (or a similar association) is configured, and a PUCCH transmission with repetitions is triggered by the UE, the associated PUCCH resources for the PUCCH transmission is determined according to the ID of the PUCCH resource using for the first repetition of the PUCCH transmission and the configured table above.

For example, Table 2 can be configured for UE. A SR (Scheduling Request) PUCCH transmission with repetitions can be triggered by the UE, and PUCCH1 may be used for the first repetition of the SR PUCCH transmission in PCell. Then, the BS and UE may determine the associated PUCCH resource according to the PUCCH1 ID and Table 2. So, PUCCH-1 from the SCell is used for the repetition of the SR PUCCH transmission in the SCell.

As another example, Table 2 can be configured for UE. A CSI PUCCH transmission with repetitions is transmitted by the UE, and PUCCH1 is used for the first repetition of the CSI PUCCH transmission in the PCell. The BS and UE may determine the associated PUCCH resource according to the PUCCH1 ID and Table 2. PUCCH-1 from SCell is used for the repetition of the CSI (Channel Status Information) PUCCH transmission in SCell.

### Embodiment 3

Traditionally, an SPS (Semi-Persistent Scheduling) configuration is only configured with a PDSCH (Physical Downlink Shared Channel) resource, and UE transmits the DL (downlink) data in the PDSCH resource at the SPS period. The PDSCH resource is always valid in all DL slots because all resources in all DL slots are available for DL transmission.

However, in the sub-band full duplex technology, some DL slots are configured with UL (uplink) subband. A part of the frequency domain resources of all or part of the symbols in a DL slot are configured as UL subband for UL transmission. Therefore, there are two types of DL slots. The first DL slot type is the DL slot containing the UL subband (defined as slot type 1). The second DL slot type is the DL slot without UL subband (defined as slot type 2). The resources that can be used for PDSCH transmission in slot type 1 and slot type 2 are different.

In this case, if only one PDSCH resource is configured for an SPS configuration as used traditionally, the one PDSCH resource may be invalid in one of the slot types (either slot type 1 or slot type 2), leading to inefficient SPS transmission. The following paragraphs discuss the relevant aspect to improve the current arrangement.

According to one implementation, one SPS configuration can be configured with multiple PDSCH resources. The BS and UE may agree to determine which PDSCH resource is transmitted at an SPS period according to the following rules:

The BS and UE may always use the first valid PDSCH resource at the SPS period selected from the plurality of configured PDSCH resources in the slot where the SPS period is located. The first valid PDSCH resource can be determined according to a starting symbol of the PDSCH resource and determined according to whether the PDSCH resource overlaps the UL subband resource in the slot where the SPS period is located.

For example, PDSCH resources overlapping with a UL subband in the time-frequency domain may be invalid for the SPS period in the slot where the SPS period is located. Except for the invalid PDSCH resource, the PDSCH resource with the earliest start symbol in the remaining PDSCH resources can be the first valid PDSCH resource. For multiple PDSCH resources with the same earliest start symbol, the PDSCH resource with the largest (or smallest) number of symbols can be determined as the first valid PDSCH resource.

According to another implementation, one SPS configuration can be configured with multiple PDSCH resources. At least one PDSCH resource from the multiple PDSCH resources can be associated with a slot type 1, and at least one PDSCH resource from the multiple PDSCH resources can be associated with the slot type 2. The BS and UE may agree to determine which PDSCH resource is transmitted at an SPS period according to the following steps including determining the slot type of the slot where an SPS period is located; and determining the first valid PDSCH resource from the PDSCH resources associated with the determined slot type.

If the determined slot type is only associated with one PDSCH resource, then the one PDSCH resource can be determined as the first valid PDSCH resource directly.

According to another example, if the determined slot type is associated with multiple PDSCH resources, the first valid PDSCH resource can be determined according to the start symbol of the multiple PDSCH resources and according to whether the multiple PDSCH resources overlap with the UL subband in the time-frequency domain.

For example, PDSCH resources overlapping with a UL subband in the time-frequency domain can be invalid in the determined slot where the SPS period is located. Except for the invalid PDSCH resource, the PDSCH resource with the earliest start symbol in the remaining PDSCH resources associated with the determined slot type can be the first valid PDSCH resource. For multiple PDSCH resources with the same earliest start symbol, the PDSCH resource with the largest (or smallest) number of symbols can be determined as the first valid PDSCH resource.

### Embodiment 4

Traditionally, a configuration grant (CG) PUSCH (Physical Uplink Shared Channel) (e.g., semi static uplink transmission) can be configured with only one PUSCH resource. The UE transmits UL data in the PUSCH resource at the CG PUSCH period. The PUSCH resource is always valid in all UL slots because all resources in all UL slots are available for UL transmission.

However, in sub-band full duplex technology, some DL slots are configured with UL subband. A part of the frequency domain resources of all or a part of the symbols in a DL slot is configured as UL subband for UL transmission. In this way, CG PUSCH can also be transmitted in UL subband in the DL slots.

Accordingly, there are two types of slots for the CG PUSCH. The first slot type is the DL slot containing the UL subband (defined as slot type 1); the second slot type is the UL slot without UL subband (defined as slot type 2). The resources that can be used for PUSCH transmission in slot type 1 and slot type 2 are different.

If only one PUSCH resource is configured for a CG PUSCH configuration according to the traditional technology, then the one PUSCH resource may be invalid in one of the slot types, leading to inefficient CG PUSCH transmission. The following methods are provided to address the issues.

According to one implementation, CG PUSCH configuration can be configured with multiple PUSCH resources. The BS and UE may agree to determine which PUSCH resource is transmitted at the CG PUSCH period according to the following step including: always using the first valid PUSCH resource at the CG PUSCH period selected from the multiple configured PUSCH resources in the slot where the CG PUSCH period is located. The first valid PUSCH resource can be determined according to the starting symbol of the PUSCH resource and whether the PUSCH resource overlaps the DL resource in the slot where the CG PUSCH period is located. Alternatively, the first valid PUSCH resource can be determined according to whether the PUSCH resource is in the UL subband configured in the DL slot.

For example, PUSCH resources overlapping with a DL resource in the time-frequency domain can be invalid for the CG PUSCH period in the slot where the CG PUSCH period is located. Except for the invalid PUSCH resource, the PUSCH resource with the earliest start symbol in the remaining PUSCH resources can be the first valid PUSCH resource. For multiple PUSCH resources with the same earliest start symbol, the PUSCH resource with the largest (or smallest) number of symbols can determined as the first valid PUSCH resource.

According to another implementation, one CG PUSCH configuration can be configured with multiple (one or more) PDSCH resources. At least one PUSCH resource from the multiple PUSCH resources as configured can be associated with the slot type 1, and at least one PUSCH resource from the multiple PUSCH resources is associated with the slot type 2. The BS and UE may agree to determine which PUSCH resource is transmitted at an CG PUSCH period according to the following steps including determining the type of the slot where an CG PUSCH period is located; and determining the first valid PUSCH resource from the PUSCH resources associated with the determined slot type. If the determined slot type is only associated with one PUSCH resource, then the one PUSCH resource is directly determined as the first valid PUSCH resource. If the determined slot type is associated with multiple PUSCH resources, the first valid PUSCH resource can be determined according to the start symbol of the multiple PUSCH resources and according to whether the multiple PUSCH resources overlap with the DL resources in the time-frequency domain.

For example, PUSCH resources overlapping with DL resources in the time-frequency domain can be invalid in the slot where the CG PUSCH period is located. Except for the invalid PUSCH resource, the PUSCH resource with the earliest start symbol in the remaining PUSCH resources associated with the determined slot type can be the first valid PUSCH resource. For multiple PUSCH resources with the same earliest start symbol, the PUSCH resource with the largest (or smallest) number of symbols is determined as the first valid PUSCH resource.

According to one embodiment, a wireless communication method is provided. The method includes obtaining configuration information; and determining a PUCCH resource from at least two cells for a PUCCH transmission according to the configuration information, wherein the configuration information includes a PUCCH cell switching pattern indicating the PUCCH resource from the at least two cells.

According to one embodiment, a wireless communication method is provided. The method includes obtaining configuration information; and determining one or more PUCCH resources from at least two cells for a PUCCH transmission according to the configuration information, wherein the configuration information includes a PUCCH cell switching pattern configured for the at least two cells.

According to one embodiment, a wireless communication method is provided. The method includes providing configuration information; and receiving, from user equipment, a PUCCH transmission transmitted on one or more PUCCH resources selected from at least two cells according to the configuration information, wherein the configuration information including a PUCCH cell switching pattern configured for the at least two cells.

According to one exemplary implementation of the disclosed embodiments, the PUCCH transmission includes a PUCCH transmission with repetitions and determining one or more PUCCH resources includes determining a plurality of PUCCH resources from the at least two cells on a slot by slot basis.

According to one exemplary implementation of the disclosed embodiments, the configuration information includes downlink control information (DCI) and the DCI includes at least two PRI fields.

According to one exemplary implementation of the disclosed embodiments, a number of the PRI fields is equal to a number of the at least two cells.

According to one exemplary implementation of the disclosed embodiments, the at least two PRI fields are configured to indicate the PUCCH resources of the at least two cells respectively.

According to one exemplary implementation of the disclosed embodiments, the method further includes transmitting an initial PUCCH repetition and at least one following PUCCH repetition subsequent to the initial PUCCH repetition according to the PUCCH cell switching pattern at slots of the at least two cells.

According to one exemplary implementation of the disclosed embodiments, the configuration information includes information configured to indicate a slot of a cell used for transmitting the initial PUCCH repetition according to the PUCCH cell switching pattern.

According to one exemplary implementation of the disclosed embodiments, the slots include an initial slot and at least one following slot and the at least one following slot from the PUCCH cell meets conditions that:
the at least one following slot in the PUCCH cell is capable of providing an uplink symbol or a flexible symbol with a same index of a starting symbol of the indicated or configured PUCCH resource for the PUCCH transmission in a cell of the PUCCH resource; and
the at least one following slot in the PUCCH cell is capable of providing consecutive uplink or flexible symbols starting from the uplink symbol or the flexible symbol, with a number of the consecutive symbols equal to or greater than a number of the symbols configured for the indicated or configured PUCCH resource for the PUCCH transmission in a cell of the PUCCH resource.

According to one exemplary implementation of the disclosed embodiments, the initial slot and the at least one following slot belong to different cells.

According to one exemplary implementation of the disclosed embodiments, the configuration information includes association information between candidate PUCCH resources of the at least two cells.

According to one exemplary implementation of the disclosed embodiments, the configuration information further includes repetition factors corresponding to the associations of PUCCH resources indicated by the association information respectively.

According to one exemplary implementation of the disclosed embodiments, a repetition factor of the PUCCH transmission is the same as a repetition factor of the indicated or configured PUCCH resource for an initial PUCCH repetition of the PUCCH transmission.

According to one exemplary implementation of the disclosed embodiments, the repetition factor of the indicated or configured PUCCH resource is configured by an RRC singling.

According to one exemplary implementation of the disclosed embodiments, a repetition factor of the PUCCH transmission is a sum of repetition factors of the associated PUCCH resources of the at least two cells used to transmit PUCCH repetitions of the PUCCH transmission.

According to one exemplary implementation of the disclosed embodiments, determining one or more PUCCH resources from at least two cells includes determining the PUCCH resources used to transmit PUCCH repetitions of the PUCCH transmission according to the association information and a PRI.

According to one exemplary implementation of the disclosed embodiments, the configuration information further includes PRI information associated with a PUCCH association indicated by the association information.

According to one exemplary implementation of the disclosed embodiments, a first PUCCH resource of a first cell of the at least two cells is associated with a second PUCCH resource of a second cell of the at least two cells, and the first and the second PUCCH resources meet at least one of the following conditions that:
the first and the second PUCCH resources have a same number of symbols;
the first and the second PUCCH resources have a same format;
the first and the second PUCCH resources have same coding and modulation;
the first and the second PUCCH resources have a same subcarrier spacing;
the first and the second PUCCH resources have a same cyclic prefix; or
the first and the second PUCCH resources have a same repetition factor.

According to one embodiments of this disclosure, a wireless communication method is provided. The method includes providing configuration information; and receiving, from user equipment, a PUCCH transmission transmitted on at least two cells according to the configuration information, wherein the configuration information including a PUCCH cell switching pattern indicating PUCCH resource from the at least two cells for the PUCCH transmission.

According to one exemplary implementation of the disclosed embodiments, receiving, from the user equipment, the PUCCH transmission includes receiving an initial PUCCH repetition and at least one following PUCCH repetition subsequent to the initial PUCCH repetition according to the PUCCH cell switching pattern at slots of the at least two cells.

According to one exemplary implementation of the disclosed embodiments, the PUCCH transmission transmitted on at least two cells according to the configuration information includes PUCCH repetitions transmitted on PUCCH resources determined according to the association information and a PRI.

Various exemplary embodiments of the present disclosure are described herein with reference to the accompanying figures to enable a person of ordinary skill in the art to make and use the present disclosure. The present disclosure is not limited to the exemplary embodiments and applications described and illustrated herein. Additionally, the specific order and/or hierarchy of steps in the methods disclosed herein are merely exemplary approaches. Based upon design preferences, the specific order or hierarchy of steps of the disclosed methods or processes can be re-arranged while remaining within the scope of the present disclosure. Thus, those of ordinary skill in the art would understand that the methods and techniques disclosed herein present various steps or acts in exemplary order(s), and the present disclosure is not limited to the specific order or hierarchy presented unless expressly stated otherwise.

This disclosure is intended to cover any conceivable variations, uses, combination, or adaptive changes of this disclosure following the general principles of this disclosure, and includes well-known knowledge and conventional technical means in the art and undisclosed in this application.

It is to be understood that this disclosure is not limited to the precise structures or operation described above and shown in the accompanying drawings, and various modifications and changes may be made without departing from the scope of this application. The scope of this application is subject only to the appended claims.

The methods, devices, processing, circuitry, and logic described above may be implemented in many different ways and in many different combinations of hardware and software. For example, all or parts of the implementations may be circuitry that includes an instruction processor or controller, such as a Central Processing Unit (CPU), microcontroller, or a microprocessor; or as an Application Specific Integrated Circuit (ASIC), Programmable Logic Device (PLD), or Field Programmable Gate Array (FPGA); or as circuitry that includes discrete logic or other circuit components, including analog circuit components, digital circuit components or both; or any combination thereof. The circuitry may include discrete interconnected hardware components or may be combined on a single integrated circuit die, distributed among multiple integrated circuit dies, or implemented in a Multiple Chip Module (MCM) of multiple integrated circuit dies in a common package, as examples.

Accordingly, the circuitry may store or access instructions for execution, or may implement its functionality in hardware alone. The instructions may be stored in a tangible storage medium that is other than a transitory signal, such as a flash memory, a Random Access Memory (RAM), a Read Only Memory (ROM), an Erasable Programmable Read Only Memory (EPROM); or on a magnetic or optical disc, such as a Compact Disc Read Only Memory (CDROM), Hard Disk Drive (HDD), or other magnetic or optical disk; or in or on another machine-readable medium. A product, such as a computer program product, may include a storage medium and instructions stored in or on the medium, and the instructions when performed by the circuitry in a device may cause the device to implement any of the processing described above or illustrated in the drawings.

The implementations may be distributed. For instance, the circuitry may include multiple distinct system components, such as multiple processors and memories, and may span multiple distributed processing systems. Parameters, databases, and other data structures may be separately stored and managed, may be incorporated into a single memory or database, may be logically and physically organized in many different ways, and may be implemented in many different ways. Example implementations include linked lists, program variables, hash tables, arrays, records (e.g., database records), objects, and implicit storage mechanisms. Instructions may form parts (e.g., subroutines or other code sections) of a single program, may form multiple separate programs, may be distributed across multiple memories and processors, and may be implemented in many different ways. Example implementations include stand-alone programs, and as part of a library, such as a shared library like a Dynamic Link Library (DLL). The library, for example, may contain shared data and one or more shared programs that include instructions that perform any of the processing described above or illustrated in the drawings, when performed by the circuitry.

In some examples, each unit, subunit, and/or module of the system may include a logical component. Each logical component may be hardware or a combination of hardware and software. For example, each logical component may include an application specific integrated circuit (ASIC), a Field Programmable Gate Array (FPGA), a digital logic circuit, an analog circuit, a combination of discrete circuits, gates, or any other type of hardware or combination thereof. Alternatively or in addition, each logical component may include memory hardware, such as a portion of the memory, for example, that includes instructions executable with the processor or other processors to implement one or more of the features of the logical components. When any one of the logical components includes the portion of the memory that includes instructions executable with the processor, the logical component may or may not include the processor. In some examples, each logical component may just be the portion of the memory or other physical memory that includes instructions executable with the processor or other processor to implement the features of the corresponding logical component without the logical component including any other hardware. Because each logical component includes at least some hardware even when the included hardware includes software, each logical component may be interchangeably referred to as a hardware logical component.

A second action may be said to be “in response to” a first action independent of whether the second action results directly or indirectly from the first action. The second action may occur at a substantially later time than the first action and still be in response to the first action. Similarly, the second action may be said to be in response to the first action even if intervening actions take place between the first action and the second action, and even if one or more of the intervening actions directly cause the second action to be performed. For example, a second action may be in response to a first action if the first action sets a flag and a third action later initiates the second action whenever the flag is set.

To clarify the use of and to hereby provide notice to the public, the phrases “at least one of <A>, <B>, . . . and <N>” or “at least one of <A>, <B>, . . . <N>, or combinations thereof” or “<A>, <B>, . . . and/or <N>” are defined by the Applicant in the broadest sense, superseding any other implied definitions hereinbefore or hereinafter unless expressly asserted by the Applicant to the contrary, to mean one or more elements selected from the group comprising A, B, . . . and N. In other words, the phrases mean any combination of one or more of the elements A, B, . . . or N including any one element alone or the one element in combination with one or more of the other elements which may also include, in combination, additional elements not listed.

1. A wireless communication method, comprising:
obtaining configuration information; and
determining one or more physical uplink control channel (PUCCH) resources from at least two cells for a PUCCH transmission according to the configuration information, wherein the configuration information includes a PUCCH cell switching pattern configured for the at least two cells.

2. The method of claim 1, wherein the PUCCH transmission includes a PUCCH transmission with repetitions, wherein one or more PUCCH cells that carry the one or more determined PUCCH resources are determined according to the PUCCH cell switching pattern on a slot by slot basis.

3. The method of claim 1, wherein the configuration information includes downlink control information (DCI) and the DCI includes at least two PUCCH resource indication (PRI) fields, and wherein:
a number of the PRI fields is equal to a number of the at least two cells, or
the at least two PRI fields are configured to indicate the PUCCH resources of the at least two cells respectively.

4-5. (canceled)

6. The method of claim 1, further comprising transmitting an initial PUCCH repetition and at least one following PUCCH repetition subsequent to the initial PUCCH repetition according to the PUCCH cell switching pattern at slots of the at least two cells, wherein the configuration information comprises information configured to indicate a slot of a cell used for transmitting the initial PUCCH repetition according to the PUCCH cell switching pattern.

7. (canceled)

8. The method of claim 1, further comprising transmitting an initial PUCCH repetition and at least one following PUCCH repetition subsequent to the initial PUCCH repetition according to the PUCCH cell switching pattern at slots of the at least two cells, wherein the slots include an initial slot and at least one following slot, wherein the initial slot and the at least one following slot belong to different cells, and wherein the at least one following slot from the PUCCH cell meets conditions that:
the at least one following slot in the PUCCH cell is capable of providing an uplink symbol or a flexible symbol with a same index of a starting symbol of the indicated or configured PUCCH resource for the PUCCH transmission in a cell of the PUCCH resource; and
the at least one following slot in the PUCCH cell is capable of providing consecutive uplink or flexible symbols starting from the uplink symbol or the flexible symbol, with a number of the consecutive symbols equal to or greater than a number of the symbols configured for the indicated or configured PUCCH resource for the PUCCH transmission in a cell of the PUCCH resource.

9. (canceled)

10. The method of claim 1, wherein the configuration information comprises association information between candidate PUCCH resources of the at least two cells,
and wherein:
the configuration information further comprises repetition factors corresponding to the associations of the candidate PUCCH resources indicated by the association information respectively;
determining one or more PUCCH resources from at least two cells comprises determining the PUCCH resources used to transmit PUCCH repetitions of the PUCCH transmission according to the association information and a PUCCH resource indication (PRI); or
the configuration information further comprises PRI information associated with a PUCCH association indicated by the association information.

11. (canceled)

12. The method of claim 1, wherein a repetition factor of the PUCCH transmission is the same as a repetition factor of the indicated or configured PUCCH resource for an initial PUCCH repetition of the PUCCH transmission, and wherein the repetition factor of the indicated or configured PUCCH resource is configured by an RRC signaling.

13. (canceled)

14. The method of claim 1, wherein a repetition factor of the PUCCH transmission is a sum of repetition factors of associated PUCCH resources of the at least two cells used to transmit PUCCH repetitions of the PUCCH transmission.

15-16. (canceled)

17. The method of claim 1, wherein a first PUCCH resource of a first cell of the at least two cells is associated with a second PUCCH resource of a second cell of the at least two cells, and the first and the second PUCCH resources meet at least one of the following conditions that:
the first and the second PUCCH resources have a same number of symbols;
the first and the second PUCCH resources have a same format;
the first and the second PUCCH resources have same coding and modulation;
the first and the second PUCCH resources have a same subcarrier spacing;
the first and the second PUCCH resources have a same cyclic prefix; or
the first and the second PUCCH resources have a same repetition factor.

18. A wireless communication method, comprising:
providing configuration information; and
receiving, from user equipment, a physical uplink control channel (PUCCH) transmission transmitted on one or more PUCCH resources selected from at least two cells according to the configuration information, wherein the configuration information including a PUCCH cell switching pattern configured for the at least two cells.

19. The method of claim 18, wherein the PUCCH transmission includes a PUCCH transmission with repetitions, wherein one or more PUCCH cells that carry the one or more PUCCH resources are determined according to the PUCCH cell switching pattern on a slot by slot basis.

20. The method of claim 18, wherein the configuration information includes downlink control information (DCI) and the DCI includes at least two PUCCH resource indication (PRI) fields, and wherein:
a number of the PRI fields is equal to a number of the at least two cells, or
the at least two PRI fields are configured to indicate the PUCCH resources of the at least two cells respectively.

21-22. (canceled)

23. The method of claim 18, wherein:
receiving, from the user equipment, the PUCCH transmission comprises receiving an initial PUCCH repetition and at least one following PUCCH repetition subsequent to the initial PUCCH repetition according to the PUCCH cell switching pattern at slots of the at least two cells;
the configuration information comprises information configured to indicate a slot of a cell used for transmitting the initial PUCCH repetition according to the PUCCH cell switching pattern;
the slots include an initial slot and at least one following slot;
the initial slot and the at least one following slot belong to different at least one cells; and
the at least one following slot from the PUCCH cell meets conditions that:
the at least one following slot in the PUCCH cell is capable of providing an uplink symbol or a flexible symbol with a same index of a starting symbol of the indicated or configured PUCCH resource for the PUCCH transmission in a cell of the PUCCH resource; and
the at least one following slot in the PUCCH cell is capable of providing consecutive uplink or flexible symbols starting from the uplink symbol or the flexible symbol, with a number of the consecutive symbols equal to or greater than a number of the symbols configured for the indicated or configured PUCCH resource for the PUCCH transmission in a cell of the PUCCH resource.

24-26. (canceled)

27. The method of claim 18, wherein the configuration information comprises association information between candidate PUCCH resources of the at least two cells, and wherein:
the PUCCH transmission transmitted on one or more PUCCH resources selected from at least two cells according to the configuration information comprises PUCCH repetitions transmitted on PUCCH resources determined according to the association information and a PUCCH resource indication (PRI), or
the configuration information further comprises PRI information associated with a PUCCH association indicated by the association information.

28. The method of claim 18, wherein the configuration information further comprises repetition factors corresponding to associations of the candidate PUCCH resources indicated by association information respectively.

29. The method of claim 18, wherein a repetition factor of the PUCCH transmission is the same as a repetition factor of the indicated or configured PUCCH resource for an initial PUCCH repetition of the PUCCH transmission, and wherein the repetition factor of the indicated or configured PUCCH resource is configured by an RRC signaling.

30. (canceled)

31. The method of claim 18, wherein a repetition factor of the PUCCH transmission is a sum of repetition factors of associated PUCCH resources of the at least two cells used to transmit PUCCH repetitions of the PUCCH transmission.

32-33. (canceled)

34. The method of claim 18, wherein a first PUCCH resource of a first cell of the at least two cells is associated with a second PUCCH resource of a second cell of the at least two cells, and the first and the second PUCCH resources meet at least one of the following conditions that:
the first and the second PUCCH resources have a same number of symbols;
the first and the second PUCCH resources have a same format;
the first and the second PUCCH resources have same coding and modulation;
the first and the second PUCCH resources have a same subcarrier spacing;
the first and the second PUCCH resources have a same cyclic prefix; or
the first and the second PUCCH resources have a same repetition factor.

35. A wireless communication apparatus, comprising a memory storing one or more programs and one or more processors electrically coupled to the memory and configured to execute the one or more programs to perform the method of claim 1.

36. A non-transitory computer-readable storage medium, storing one or more programs, the one or more program being configured to, when executed by a processor, cause to perform the method of claim 1.
